(19) United States
(12) Patent Application Publication
(10) Pub. No.: US 2014/0261614 A1
(43) Pub. Date: Sep. 18, 2014

(54) METHOD OF INSTALLING AND OPERATING A SOLAR MODULE ARRAY

(71) Applicant: First Solar, Inc., Perrysburg, OH (US)

(72) Inventors: Michael Belikoff, Mendham, NJ (US); Stephen Eber, Teaneck, NJ (US); Jigish Trivedi, Perrysburg, OH (US)

(21) Appl. No.: 14/196,021

(22) Filed: Mar. 4, 2014

Related U.S. Application Data
(60) Provisional application No. 61/783,273, filed on Mar. 14, 2013.

(51) Int. Cl. G01R 31/40

(52) U.S. Cl. CPC H02S 50/00
USPC 136/244; 29/428

(57) ABSTRACT

A method of installing and managing a solar module array includes determining a desired output capacity of the array, providing a first number of solar modules to generate electrical power at the desired output capacity, installing the first number of solar modules as the array at a plant site, and operating the array to generate electrical power. The array is monitored for an event that triggers providing a second number of the solar modules as recharge modules to compensate for degradation of the desired output capacity based upon at least one of a predetermined percentage of degradation and a predetermined period of operation. The array is monitored for the event over a monitoring period less than the operating life of the array to trigger further provision of the recharge modules as needed.

### CROSS-REFERENCE TO RELATED APPLICATION

This application claims the benefit of priority of U.S. Provisional Patent Application Ser. No. 61/783,273 filed on Mar. 14, 2013 hereby incorporated herein by reference in its entirety.

### FIELD OF THE INVENTION

This invention relates to a method of installing and operating an array of solar modules to maintain an initial output capacity for a predetermined period.

### BACKGROUND OF THE INVENTION

Photovoltaic power generating systems are currently constructed by installing a foundation system such as a series of posts or footings, a solar module structural support frame, which can involve brackets, tables or rails and clips for mounting individual solar modules to the support frame. The solar modules are electrically wired together into photovoltaic (PV) arrays which arrays are typically further wired together with other arrays and connected to one or more aggregation points which are connected to electrical inverters in a PV system.

Solar module array power plants are becoming practical as grid scale generation facilities capable of producing tens of megawatts or more, thereby decreasing the cost of solar cell modules. Larger plants are being built to satisfy mandates for renewable energy capacity. Penetration levels of plants are expected to be significant.

All PV modules experience a natural degradation of output capacity over the lifetime of operation. As a consequence, the output of the PV power plant will also degrade over time, with output capacity generally dropping in proportion to the degradation the modules experience. It would be desirable and economically advantageous to develop design strategies to mitigate the effects of module degradation and enable the PV power plant to operate with a reduced or no plant level output degradation.

### SUMMARY OF THE INVENTION

A method of installing and managing a solar module array according to the invention comprises the steps of: providing a predetermined first number of solar modules sufficient to generate electrical power at a desired output capacity when installed as a solar module array at a plant site; and providing a second number of solar modules at a frequency sufficient to compensate for degradation of the output capacity of the solar module array when installed as recharge modules cooperating with the solar module array at the plant site based upon at least one of a predetermined percentage degradation of the output capacity and a predetermined period of operation of the solar module array.

A method of installing and managing a solar module array according to the invention comprises the steps of: determining a desired output capacity of the solar module array; providing a first number of solar modules to generate electrical power at the desired output capacity; installing the first number of solar modules as the solar module array at a plant site; operating the solar module array to generate electrical power; providing a second number of the solar modules as recharge modules to compensate for degradation of the desired output capacity as the solar module array is operated based upon at least one of a predetermined percentage of degradation and a predetermined period of operation; after the second number of solar modules is installed, monitoring the solar module array during a monitoring period to detect the occurrence of an event that triggers a next recharge module installation; upon occurrence of the event being at least one of the predetermined percentage of degradation and the predetermined period of operation, performing the providing a second number of the solar modules step and, if the event has not occurred, checking for an end of the monitoring period; and if the monitoring period has not ended, performing the monitoring step and, if the monitoring period has ended, ending the performance of the method.

### DESCRIPTION OF THE DRAWINGS

The above as well as other advantages of the present invention will become readily apparent to those skilled in the art from the following detailed description of a preferred embodiment when considered in the light of the accompanying drawings in which:

FIG. 1 is a schematic diagram of a solar cell array of an electrical power generation plant having the capability of adding rows of recharge modules according to invention;

FIG. 2 is a graph of a physically constrained plant typical output capacity versus years of operation since the solar cell array installation;

FIG. 3 is a graph of annual plant output versus years of operation since the solar cell array installation of FIG. 2;

FIG. 4 is a graph of a physically unconstrained plant typical output capacity versus years of operation wherein recharge modules are being added to the solar cell array installation;

FIG. 5 is a graph of annual plant output versus years of operation since the solar cell array initial installation with recharge modules added of FIG. 4; and

FIG. 6 is a flow diagram of the method steps according to the invention.

### DETAILED DESCRIPTION OF THE INVENTION

The following detailed description and appended drawings describe and illustrate various exemplary embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

Embodiments disclosed herein provide a wiring assembly which can facilitate the interconnection of a plurality of solar panels in the field, as well as in a manufacturing facility where a plurality of solar modules may be aggregated together as a unit for installation.

A solar module recharge program according to the method and apparatus of the invention anticipates adding DC capacity after a solar cell electrical generating plant is placed into operation to compensate for natural module degradation. The necessary physical space requirement is reserved during the initial plant build-out. The recharge term and recharge capacity is optimized by considering requirements that include maximizing return on investment, life expectancy of the plant and related interconnected system assets, projected escalation and inflation rates, module efficiency, cost of capital, warranty and other parameters of interest. The module recharge program effectively maximizes life cycle energy yields, and minimizes upfront capital expenditure and associated initial capital related financing costs. The following illustrates and describes a typical solar cell array with the capability to add four rows of recharge solar cell modules.

There is shown in FIG. 1 a plan view of a solar cell array 10 having a plurality of solar cell modules 12 arranged in two columns 14a, 14b with each column having two blocks 16a, 16b, 18a and 18b. The blocks 16a and 16b each include fourteen rows 20 with each row having six of the solar cell modules 12. The blocks 18a and 18b each include fifteen rows 20 with each row having six of the solar cell modules 12 except that the top three rows of the block 18a have only four of the modules 12 to form a space 22 near the center of the array 10 for electrical power management equipment such as inverters for converting the DC output of the modules 12 to AC. At the top of the blocks 16a and 16b and at the bottom of the blocks 18a and 18b are two rows 24, similar to the rows 20, for recharge modules as discussed hereinbelow. This configuration is simply an example of one embodiment according of the invention. The number of blocks in the array, the number of rows in each block and the number of modules in each row can be varied, as desired.

At initial build of the plant of a non-limiting example, the solar cell modules 12 are installed in the rows 20 to provide an electrical power output baseline capacity of 38.46 MWdc (nominally 30.28 MWac) at standard operating conditions beginning at Year “0” as shown in the graph of FIG. 2 by a line 30. It is understood that the capacity illustrated by FIG. 2 is exemplary in nature and that the plant may have any power output baseline capacity, as desired. The plant capacity degrades over the operating life (Years “1-30”) as indicated by the downward slope of the line 30. If plant build site is physically constrained, the installed plant capacity must be reduced in size as represented by the rows 20 to allow for future module addition. For a ten year recharge period, in which the degradation rate is about 0.7%, the reduction in initial installed capacity is 7% as shown by the line 32. It is understood that the degradation rate may be below 0.7%, such as from about 0.3% to about 0.7% and from about 0.1% to about 0.3%, for example, though the degradation rate to be compensated may be any rate, as necessary, or the degradation rate may be above 0.7%. Similarly, the degradation rate may change over time, for example, the degradation rate may increase or decrease as the plant remains in service. During the Years “1-10”, recharge modules 12 are added in the rows 24 to maintain the initial baseline capacity. After Year “10”, there is no more room in the rows 24 to add modules and the plant output degradation matches that of the line 30 thereafter. Note that the portion of the line 32 between the years “0” through “10” connects points representing the baseline capacity value after each recharge module addition. The actual capacity slopes downwardly at the same angle as the line 30 between the recharge module additions during the first ten years so that a continuous measure of capacity would have a sawtooth shape.

If the plant site is constrained and provisions for recharge are included, the initial plant capacity would be reduced by 7% to accommodate the physical space required to add the recharge modules 12 on an annual basis. This effectively reduces the annual yield by 7% in the first year of operation, but during the thirty year projected life for the project, the yield is only reduced by 1.35%. The initial capital expenditure for the plant is 7% less. However, there are annual costs for adding the recharge modules. FIG. 3 shows the MWHac yield per years of operation of the array 10 with the vertical lines 34 representing standard degradation without providing for recharge modules and the lines 36 representing degradation using recharge modules.

If the plant site is physically unconstrained, the recharge modules 12 can be added to the baseline project represented by the rows 20. As illustrated in FIG. 4, for an initial ten year recharge period, in which degradation rate is 0.7%, there is no reduction in initial installed capacity as represented by a line 38 versus the standard degradation line 30. Sufficient modules 12 to restore the plant would be added to the base plant rows 20 (7% additional modules after the ten year recharge period). As explained above, the continuous measure of capacity during the first ten years would have a sawtooth shape for that portion of the line 38. FIG. 5 presents the additional energy yield for each year of plant operations with the vertical lines 40 representing standard degradation without providing for recharge modules and the lines 42 representing degradation using recharge modules.

In the unconstrained site example, a non-limiting example includes a baseline power project is nominally 30.28 MWac, and 38.46 MWdc (1.27 DC:AC). It is understood that the unconstrained site example is merely exemplary, and that the baseline power in any amount desired. If provisions for recharge are included, the initial plant capacity would be the same as the baseline plant, and the array 10 would be physically sized to accommodate the physical space required to add recharge modules 12 on an annual basis. The first year annual yield is the same for both the baseline plant and the recharge plant, but during the thirty year projected life for the project, the yield is increased by 6.8%. The initial capital expenditure for the baseline plant and the recharge plant is the same. However, there are annual costs for adding the recharge modules for ten years.

The module recharge program can be offered as an optional service contract by the solar cell module manufacturer. The recharge program service contract can include a guarantee that the plant energy yield is restored following recharge to first year guarantee ratings at standard conditions for the term of recharge. Adding modules during recharge is less expensive than providing for a larger plant, because additional modules and the associated AC equipment are not required.

The steps of the method according to the invention include designing each block in the array 10 to accept additional capacity as rows 24 shown in FIG. 1 taking into account whether the construction site is constrained or unconstrained. The necessary space to accommodate the recharge capacity will be made available contiguous to each block. The ground shall be prepared during the initial construction phase, including grub and grade.

When the array 10 degrades to produce 99.5% of guaranteed energy yield at standard conditions, recharge shall commence. Recharge includes the following activities: post installation; table assembly; module installation; DC wiring and connection to combiners; commissioning; and acceptance testing. The recharge will guarantee that the array is restored to 100.0% AC energy yield. The recharge program shall last ten years from the commercial operation start date.

The module recharge program can be offered as an alternative to the base plant design, and includes a service contract with an annual fee for 10 years, but the service contract may be for any amount of time less than a life of the plant. Under the service contract, the solar cell module manufacturer guarantees that for a fixed period, ten years in the examples above, following acceptance and commercial operation of the plant, the energy yield shall be equal to or greater than the first year guaranteed energy output.

There is shown in FIG. 6 a flow diagram of the method steps according to the invention. In a step 50, the desired output capacity is determined based upon many factors including the plant site being constrained or unconstrained in area for installation of the solar module array. A first number of solar modules is provided to generate electrical power at the desired output capacity. In a step 52, the first number of solar modules is installed and the solar module array is operated to generate electrical power.

In a step 54, a second number of the solar modules is provided to compensate for degradation of the desired output capacity as the solar module array is operated. It is understood that a third, a fourth, a fifth, and so on number of modules may be provided to compensate for degradation of the desired output capacity over time and in desired time increments. This step occurs based upon at least one of a predetermined percentage of degradation and a predetermined period of operation. For example, as discussed above, the expected degradation might be 7% over the first ten years of operation. Accordingly, step 54 might be scheduled for the first of 0.7% degradation and one year of operation.

After the second number of solar modules (recharge modules) is installed, a monitoring step 56 is performed to detect the occurrence of the event that triggers the next recharge module installation. Upon the occurrence of at least one of a predetermined percentage of degradation and a predetermined period of operation, the method branches at YES to the step 54. If the event has not occurred, the method branches at NO to a step 58 to check for the end of the monitoring period. According to the example above, the monitoring period is ten years from the start of operation. If the monitoring period has not ended, the method branches at NO to the step 56. If the monitoring period has ended, the method branches at YES to the step 60 that is the end of the method.

In another embodiment of the invention, recharge modules may be collected in a separate plant (not shown) having a plurality of solar cell modules rather than the recharge modules 12 being installed in the rows 24 of the solar cell array 10. The separate plant may built/installed before, during, or after the solar cell array 10 having the plurality of solar cell modules 12 is installed. The separate plant may have a scale of less than or equal to about 10 MW, such as about 1-5 MW or about 5-10 MW, as desired. Alternatively, the separate plant may have a capacity of greater than 10 MW, as desired. The separate plant is tied in to the same electrical grid that the array 10 is tied into. Accordingly, the separate plant may be installed geographically near or adjacent the array 10. The separate plant may be in operation and generating power which may be sold for a profit while the array 10 is in operation and before a recharge period. The separate power plant has an initial baseline capacity greater than an anticipated degradation of the array 10 during a desired recharge period. A design and installation of the separate power plant may also factor in an anticipated degradation of modules of the separate plant to ensure the separate plant maintains a capacity greater than the anticipated degradation of the array 10.

For example, for a ten year recharge period, in which the degradation rate is 0.7%, the reduction in initial installed capacity is 7% as shown by the line 32 of FIG. 2. During the Years “1-10”, a portion of the power generated by the separate plant is provided via the grid to maintain the initial baseline capacity of the array 10. A remaining portion of the power generated by the separate plant that is not used to maintain the initial baseline capacity may be sold or used by the owner of the separate plant. The owner of the separate plant may be an entity that installed the array 10 or an entity that has an obligation to maintain the capacity of the array 10 at the initial baseline capacity. It is understood that the power transferred from the separate plant to compensate for the degradation of the array 10 may be provided at a predetermined percentage of degradation, such as that described hereinabove and a predetermined period of operation at regular intervals, such as on an hourly, a daily, a monthly, or a yearly basis, for example, as desired. At each regular interval it is determined that either additional power is required from the separate plant or no additional power is required from the separate plant to compensate for degradation in the array 10.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. A method of installing and managing a solar module array comprising the steps of:
providing a predetermined first number of solar modules sufficient to generate electrical power at a desired output capacity when installed as a solar module array at a plant site; and
providing a predetermined second number of solar modules sufficient to compensate for degradation of the output capacity of the solar module array when installed as recharge modules cooperating with the solar module array based upon at least one of a predetermined percentage degradation of the output capacity and a predetermined period of operation of the solar module array.

2. The method according to claim 1 wherein the second number of solar modules are at the plant site.

3. The method according to claim 2 including repeating the step of providing a predetermined second number of solar modules during a selected time period of operation of the solar module array that is less than an operating life of the solar module array.

4. The method according to claim 3 including selecting the time period to be approximately ten years from a start of operation when the operating life of the solar module array is approximately thirty years.

5. The method according to claim 3 wherein the predetermined percentage of degradation is from about 0.1% to about 0.3%.

6. The method according to claim 2 including contracting with an operator of the solar module array to perform the step of providing a predetermined second number of solar modules at regular intervals during the predetermined period of operation.

7. The method according to claim 6 including selecting the regular intervals to be one year each.

8. The method according to claim 2 including when the plant site is physically constrained, selecting the desired output capacity to be less than a desired initial output capacity by an estimated degradation amount over a selected time period of operation of the solar module array that is less than an operating life of the solar module array.

9. The method according to claim 2 including when the plant site is physically unconstrained, selecting the desired output capacity equal to a desired initial output capacity.

10. The method according to claim 1 wherein the second number of solar modules are at a separate plant site.

11. The method according to claim 10 wherein the separate plant site is electrically tied into the same grid as the plant.

12. The method according to claim 11 wherein the separate power plant has an initial baseline capacity greater than an anticipated degradation of the array during a the predetermined period of operation.

13. The method according to claim 11 including a step of providing a portion of the power generated by the separate power plant through the grid to compensate for the degradation of the first number of solar modules during the predetermined period of operation.

14. The method according to claim 13 including a step of providing another portion of the power generated by the separate power plant for sale or use not associated with the plant site.

15. The method according to claim 13 wherein the step of providing a portion of the power generated by the power plant is provided at regular intervals

16. The method according to claim 15 wherein the regular intervals are one of an hourly, a daily, a monthly, or a yearly basis to ensure the initial baseline capacity of the array.

17. A method of installing and managing a solar module array comprising the steps of:
determining a desired output capacity of the solar module array;
providing a first number of solar modules to generate electrical power at the desired output capacity;
installing the first number of solar modules as the solar module array at a plant site;
operating the solar module array to generate electrical power;
providing a second number of the solar modules as recharge modules to compensate for degradation of the desired output capacity as the solar module array is operated based upon at least one of a predetermined percentage of degradation and a predetermined period of operation;
after the second number of solar modules is installed, monitoring the solar module array during a monitoring period to detect the occurrence of an event that triggers a next recharge module installation;
upon occurrence of the event being at least one of the predetermined percentage of degradation and the predetermined period of operation, performing the providing a second number of the solar modules step and, if the event has not occurred, checking for an end of the monitoring period; and
if the monitoring period has not ended, performing the monitoring step and, if the monitoring period has ended, ending the performance of the method.

18. A method of installing and managing a solar module array comprising the steps of:
determining a desired output capacity of the solar module array;
providing a first number of solar modules at a plant site to generate electrical power at the desired output capacity;
installing the first number of solar modules as the solar module array at a plant site;
operating the solar module array to generate electrical power;
providing a second number of the solar modules at a separate plant site as recharge modules to compensate for degradation of the desired output capacity as the solar module array is operated based upon at least one of a predetermined percentage of degradation and a predetermined period of operation, the separate plant site tied into the same electrical grid as the plant site;
after the second number of solar modules is installed, monitoring the solar module array during a monitoring period to detect the occurrence of an event that triggers a portion of the power generated by the second number of solar modules to be provided to maintain the desired output capacity;
upon occurrence of the event being at least one of the predetermined percentage of degradation and the predetermined period of operation, performing the providing power generated by the second number of the solar modules step and, if the event has not occurred, checking for an end of the monitoring period; and
if the monitoring period has not ended, performing the monitoring step and, if the monitoring period has ended, ending the performance of the method.
